(19) United States
(12) Patent Application Publication
(10) Pub. No.: US 2014/0292814 A1
(43) Pub. Date: Oct. 2, 2014

(54) IMAGE PROCESSING APPARATUS, IMAGE PROCESSING SYSTEM, IMAGE PROCESSING METHOD, AND PROGRAM

(71) Applicant: CANON KABUSHIKI KAISHA, Tokyo (JP)

(72) Inventors: Takuya Tsujimoto, Kawasaki-shi (JP); Masanori Sato, Yokohama-shi (JP)

(21) Appl. No.: 14/355,267

(22) PCT Filed: Dec. 11, 2012
(86) PCT No.: PCT/JP2012/007914

§ 371 Date: Apr. 30, 2014

(30) Foreign Application Priority Data
Dec. 26, 2011 (JP) 2011-283723
Oct. 1, 2012 (JP) 2012-219498

(51) Int. Cl. G06T 11/60

(52) U.S. Cl. CPC G06T 11/60
USPC 345/636

(57) ABSTRACT

An image processing apparatus includes: an acquiring unit that acquires data of an image of an object, and data of a plurality of annotations added to the image; and a display control unit that displays the image on a display apparatus together with the annotations. The data of the plurality of annotations includes position information indicating positions in the image where the annotations are added, and information concerning a user who adds the annotations to the image. The display control unit groups a part or all of the plurality of annotations and, when the plurality of annotations are added by different users, the display control unit varies a display form of the annotation for each of the users and displays the plurality of annotations while superimposing the annotations on the image.

### TECHNICAL FIELD

The present invention relates to an image processing apparatus, an image processing system, an image processing method, and a program.

### BACKGROUND ART

In recent years, in the pathological field, a virtual slide system that enables a pathological diagnosis on a display through image pickup of a test sample (a specimen) placed on a slide (preparation) and digitization of an image attracts attention as a substitute for an optical microscope, which is a tool for the pathological diagnosis. By digitizing a pathological diagnosis image using the virtual slide system, it is possible to treat a conventional optical microscope image of a test sample as digital data. As a result, it is expected that advantages such as an increase in speed of a remote diagnosis, explanation for a patient using a digital image, sharing of rare medical cases, and efficiency of educations and practices are obtained.

In order to realize operation equivalent to the optical microscope using the virtual slide system, it is necessary to digitize the entire test sample placed on the slide. It is possible to observe, through the digitization of the entire test sample, digital data created by the virtual slide system using viewer software running on a PC (Personal Computer) or a work station. When the entire test sample is digitized, usually, a data volume is extremely large with the number of pixels as many as several hundred million to several billion. A volume of data created by the virtual slide system is enormous. However, because the data volume is enormous, it is possible to observe images from a micro image (a detail enlarged image) to a micro image (an overall high-angle image) by performing enlargement and reduction processing using a viewer. Various conveniences are provided. By acquiring all kinds of necessary information in advance, it is possible to instantaneously display images from a low magnification image to a high magnification image at resolution and magnification demanded by a user.

A document managing apparatus is proposed that makes it possible to distinguish a creator of an annotation added to document data (Patent Literature 1).

### CITATION LIST

### Patent Literature

PTL 1: Japanese Patent Application Laid-Open No. H11-25077

### SUMMARY OF INVENTION

### Technical Problem

When a plurality of users add annotations to a virtual slide image, a large number of annotations are added to a region of interest (a region of attention). As a result, even if the large number of annotations concentrated in the region of interest are displayed on a display, it is extremely difficult to distinguish the respective annotations.

In particular, it is difficult to distinguish which users add the respective annotations. Even if the annotations are color-coded, when a plurality of annotations are added to the same region of interest or the same position, it is difficult to distinguish the annotations.

Therefore, an object of the present invention is to provide a technique for, even when a large number of annotations are concentrated in a region of interest, enabling a user to easily distinguish the respective annotations.

### Solution to Problem

The present invention in its first aspect provides an image processing apparatus including: an acquiring unit that acquires data of an image of an object, and data of a plurality of annotations added to the image; and a display control unit that displays the image on a display apparatus together with the annotations, wherein the data of the plurality of annotations includes position information indicating positions in the image where the annotations are added, and information concerning a user who adds the annotations to the image, and the display control unit groups a part or all of the plurality of annotations and, when the plurality of annotations are added by different users, the display control unit varies a display form of the annotation for each of the users and displays the plurality of annotations while superimposing the annotations on the image.

The present invention in its second aspect provides an image processing system including: the image processing apparatus according to the present invention; and a display apparatus that displays an image and an annotation output from the image processing apparatus.

The present invention in its third aspect provides an image processing method including: an acquiring step in which a computer acquires data of an image of an object, and data of a plurality of annotations added to the image; and a display step in which the computer displays the image on a display apparatus together with the annotations, wherein the data of the plurality of annotations includes position information indicating positions in the image where the annotations are added, and information concerning a user who adds the annotations to the image, and in the display step, the computer groups a part or all of the plurality of annotations and, when the plurality of annotations are added by different users, the computer varies a display form of the annotation for each of the users and displays the plurality of annotations while superimposing the annotations on the image.

The present invention in its fourth aspect provides a program (or a non-transitory computer readable medium recording a program) for causing a computer to execute the steps of the image processing method according to the present invention.

### Advantageous Effects of Invention

It is possible to screen-display, even when a large number of annotations are concentrated in a region of interest, an image and the annotations to enable a user to easily distinguish the respective annotations.

Further features of the present invention will become apparent from the following description of exemplary embodiments with reference to the attached drawings.

### BRIEF DESCRIPTION OF DRAWINGS

FIG. 1 is an overall view of an apparatus configuration of an image processing system according to a first embodiment.

FIG. 2 is a functional block diagram of an imaging apparatus in the image processing system according to the first embodiment.

FIG. 3 is a functional block diagram of an image processing apparatus.

FIG. 4 is a hardware configuration of the image processing apparatus.

FIG. 5 is a diagram for explaining a concept of a hierarchical image prepared in advance for each of different magnifications.

FIG. 6 is a flowchart for explaining a flow of annotation addition and presentation.

FIG. 7 is a flowchart for explaining a detailed flow of the annotation presentation.

FIG. 8A is a part of a flowchart for explaining a detailed flow of the annotation presentation.

FIG. 8B is the rest of the flowchart of FIG. 8A.

FIGS. 9A to 9F are examples of a display screen of the image processing system.

FIG. 10 is an example of the configuration of an annotation data list.

FIG. 11 is an overall view of an apparatus configuration of an image processing system according to a second embodiment.

FIG. 12 is a flowchart for explaining a flow of processing for grouping annotations.

FIGS. 13A to 13C are examples of a display screen of the image processing system according to the second embodiment.

FIG. 14 is an example of the configuration of an annotation data list according to a third embodiment.

FIG. 15 is a flowchart for explaining a flow of annotation addition according to the third embodiment.

FIG. 16 is a flowchart for explaining an example of a flow of automatic diagnosis processing.

### DESCRIPTION OF EMBODIMENTS

### First Embodiment

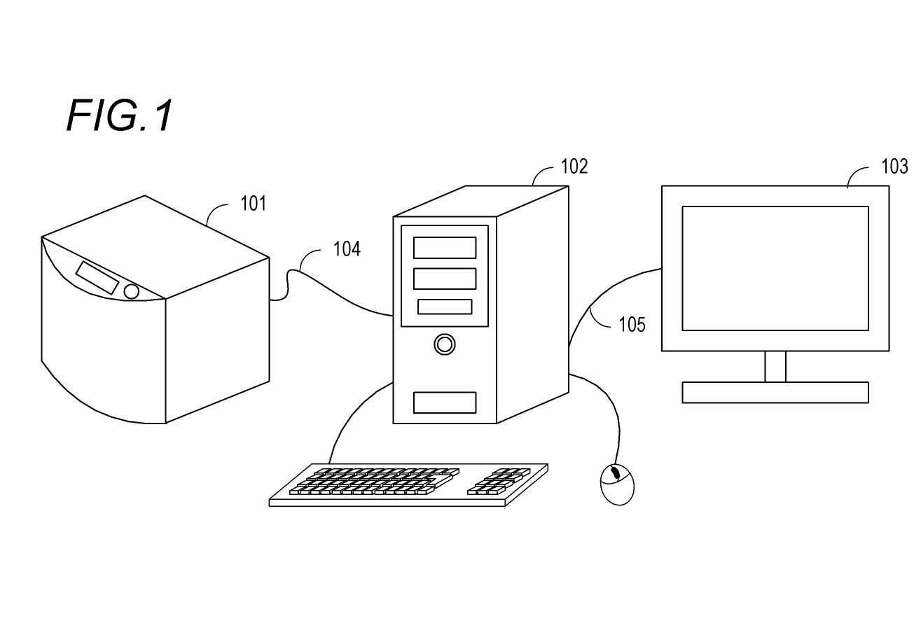

An image processing apparatus according to the present invention can be used in an image processing system including an imaging apparatus and a display apparatus. The image processing system is explained with reference to FIG. 1.

(Apparatus configuration of an image processing system)

FIG. 1 is the image processing system including the image processing apparatus according to the present invention. The image processing system includes an imaging apparatus (a microscope apparatus or a virtual slide scanner) 101, an image processing apparatus 102, and a display apparatus 103. The image processing system has a function of acquiring and displaying a two-dimensional image of a specimen (a test sample), which is an imaging target. The imaging apparatus 101 and the image processing apparatus 102 are connected by a dedicated or general-purpose I/F cable 104. The image processing apparatus 102 and the display apparatus 103 are connected by a general-purpose I/F cable 105.

As the imaging apparatus 101, a virtual slide apparatus can be used that has a function of picking up (capturing) a plurality of two-dimensional images in different positions in a two-dimensional plane direction and outputting a digital image. To acquire the two-dimensional images, a solid-state image pickup device such as a CCD (Charge Coupled Device) or a CMOS (Complementary Metal Oxide Semiconductor) is used. The imaging apparatus 101 can be configured by, instead of the virtual slide apparatus, a digital microscope apparatus in which a digital camera is attached to an eyepiece section of a normal optical microscope.

The image processing apparatus 102 is an apparatus having, for example, a function of generating, according to a request from a user, data displayed on the display apparatus 103 from a plurality of original image data acquired from the imaging apparatus 101 on the basis of the original image data. The image processing apparatus 102 includes a general-purpose computer or a work station including hardware resources such as a CPU (central processing unit), a RAM, a storage device, and various I/Fs including an operation unit. The storage device is a large capacity information storage device such as a hard disk drive. Programs and data for realizing various kinds of processing explained below, an OS (operating system), and the like are stored in the storage device. The functions explained above are realized by the CPU loading necessary programs and data to the RAM from the storage device and executing the programs. The operation unit includes a keyboard and a mouse. The operation unit is used by an operator to input various instructions.

The display apparatus 103 is a display that displays an image for observation, which is a result of arithmetic processing by the image processing apparatus 102. The display apparatus 103 includes a CRT or a liquid crystal display.

In an example shown in FIG. 1, an imaging system includes three apparatuses, i.e., the imaging apparatus 101, the image processing apparatus 102, and a display apparatus 103. However, the configuration of the present invention is not limited to this configuration. For example, an image processing apparatus integrated with a display apparatus may be used or functions of an image processing apparatus may be incorporated in an imaging apparatus. Functions of an imaging apparatus, an image processing apparatus, and a display apparatus can be realized by one apparatus. Conversely, functions of the image processing apparatus and the like may be divided and realized by a plurality of apparatuses.

(Functional Configuration of the Imaging Apparatus)

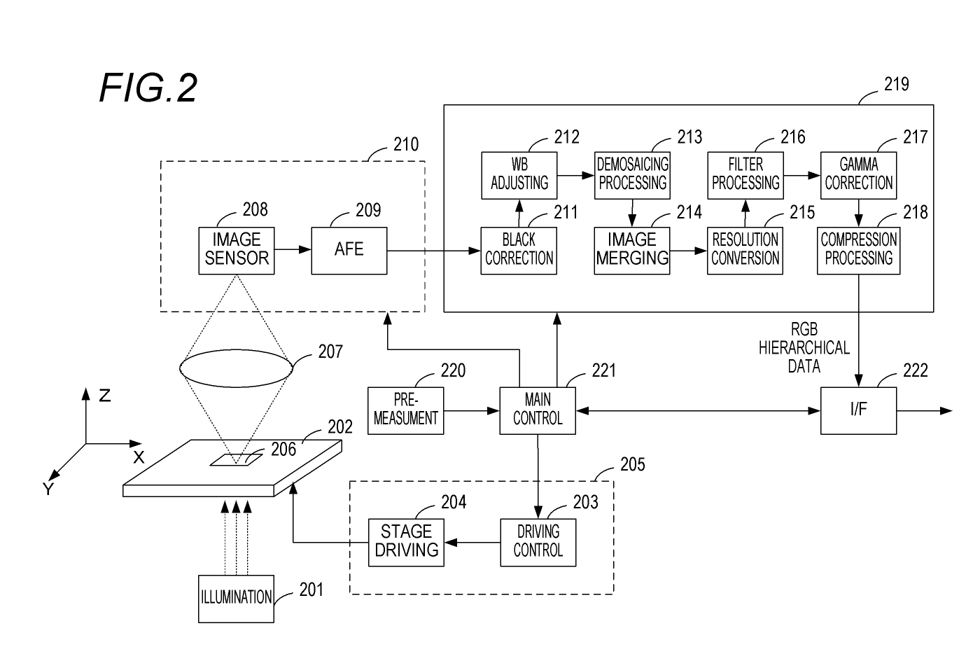

FIG. 2 is a block diagram showing a functional configuration of the imaging apparatus 101.

The imaging apparatus 101 substantially includes an illuminating unit 201, a stage 202, a stage control unit 205, a focusing optical system 207, an imaging unit 210, a development processing unit 219, a pre-measuring unit 220, a main control system 221, and a data output unit 222.

The illuminating unit 201 is means for uniformly irradiating light on a slide 206 arranged on the stage 202. The illuminating unit 201 includes a light source, an illumination optical system, and a control system for light source driving. The stage 202 is controlled to drive by the stage control unit 205 and can move in XYZ three axis directions. The slide 206 is a member obtained by sticking a slice of a tissue or a smeared cell, which is an observation target, on a slide glass and fixed under a cover glass together with a mounting agent.

The stage control unit 205 includes a driving control system 203 and a stage driving mechanism 204. The driving control system 203 receives an instruction of the main control system 221 and performs driving control of the stage 202. A moving direction, a moving amount, and the like of the stage 202 are determined on the basis of position information and thickness information (distance information) of a specimen measured by the pre-measuring unit 220 and, when necessary, an instruction from a user. The stage driving mechanism 204 drives the stage 202 according to an instruction of the driving control system 203.

The focusing optical system 207 is a lens group for focusing an optical image of a specimen of the slide 206 on an image sensor 208.

The imaging unit 210 includes an image sensor 208 and an analog front end (AFE) 209. The image sensor 208 is a one-dimensional or two-dimensional image sensor that changes a two-dimensional optical image to an electric physical amount through photoelectric conversion. For example, a CCD or a CMOS device is used as the image sensor 208. In the case of the one-dimensional sensor, a two-dimensional image is obtained by scanning in a scanning direction. An electric signal having a voltage value corresponding to the intensity of light is output from the image sensor 208. When a color image is desired as a picked-up image, for example, a 1CCD image sensor attached with a color filter of the Bayer array only has to be used. The stage 202 moves in the XY axis direction, whereby the imaging unit 210 picks up divided images of a specimen.

The AFE 209 is a circuit that converts an analog signal output from the image sensor 208 into a digital signal. The AFE 209 includes an H/V driver, a CDS (Correlated double sampling), an amplifier, an AD converter, and a timing generator explained below. The H/V driver converts a vertical synchronization signal and a horizontal synchronization signal for driving the image sensor 208 into potential necessary for sensor driving. The CDS is a correlated double sampling circuit that removes noise of a fixed pattern. The amplifier is an analog amplifier that adjusts a gain of an analog signal subjected to noise removal by the CDS. The AD converter converts the analog signal into a digital signal. When an output at a final stage of an imaging apparatus is 8 bits, the AD converter converts the analog signal into digital data quantized from about 10 bits to 16 bits taking into account processing at a later stage and outputs the digital data. Converted sensor output data is called RAW data. The RAW data is subjected to development processing by the development processing unit 219 at a later stage. The timing generator generates a signal for adjusting timing of the image sensor 208 and timing of the development processing unit 219 at the later stage.

When the CCD is used as the image sensor 208, the AFE 209 is indispensable. However, in the case of the CMOS image sensor that can perform digital output, the function of the AFE 209 is incorporated in the sensor. Although not shown in the figure, an image-pickup control unit that performs control of the image sensor 208 is present. The image-pickup control unit performs operation control for the image sensor 208 and control of operation timing such as shutter speed, a frame rate, and an ROI (Region Of Interest).

The development processing unit 219 includes a black correction unit 211, a white-balance adjusting unit 212, a demosaicing processing unit 213, an image-merging processing unit 214, a resolution-conversion processing unit 215, a filter processing unit 216, a gamma correction unit 217, and a compression processing unit 218. The black correction unit 211 performs processing for subtracting black correction data obtained during light blocking from pixels of the RAW data. The white-balance adjusting unit 212 performs processing for reproducing a desired white color by adjusting gains of RGB colors according to a color temperature of light of the illuminating unit 201. Specifically, data for white balance correction is added to the RAW data after the black correction. When a single-color image is treated, the white balance adjustment processing is unnecessary. The development processing unit 219 generates hierarchical image data explained below from the divided image data of the specimen picked up by the imaging unit 210.

The demosaicing processing unit 213 performs processing for generating image data of the RGB colors from the RAW data of the Bayer array. The demosaicing processing unit 213 interpolates values of peripheral pixels (including pixels of same colors and pixels of other colors) in the RAW data to thereby calculate values of the RGB colors of a pixel of attention. The demosaicing processing unit 213 executes correction processing (interpolation processing) for a defective pixel as well. When the image sensor 208 does not include a color filter and a single-color image is obtained, the demosaicing processing is unnecessary.

The image-merging processing unit 214 performs processing for merging (joining) image data, which is obtained by the image sensor 208 by dividing an imaging range, and generating large volume image data in a desired imaging range. In general, a presence range of a specimen is wider than an imaging range that can be acquired in one image pickup by an existing image sensor. Therefore, one two-dimensional image data is generated by joining divided image data. For example, when it is assumed that an image in a range of a 10 mm square on the slide 206 is picked up at resolution of 0.25 um (micrometer), the number of pixels on one side is 10 mm/0.25 um, i.e., 40,000 pixels. A total number of pixels is a square of the number of pixels on one side, i.e., 1.6 billion. To acquire image data having 1.6 billion pixels using the image sensor 208 having 10 M (10 million) pixels, it is necessary to divide a region into 1.6 billion/10 million, i.e., 160 to perform image pickup. As a method of joining a plurality of image data, there are, for example, a method of aligning and joining the image data on the basis of position information of the stage 202, a method of joining corresponding points or lines of a plurality of divided images to correspond to one another, and a method of joining divided image data on the basis of position information of the divided image data. When the image data are joined, the image data can be smoothly joined by interpolation processing such as 0th-order interpolation, linear interpolation, or high-order interpolation. In this embodiment, it is assumed that one large volume image is generated. However, as a function of the image processing apparatus 102, a configuration for joining divided and acquired images when display data is generated may be adopted.

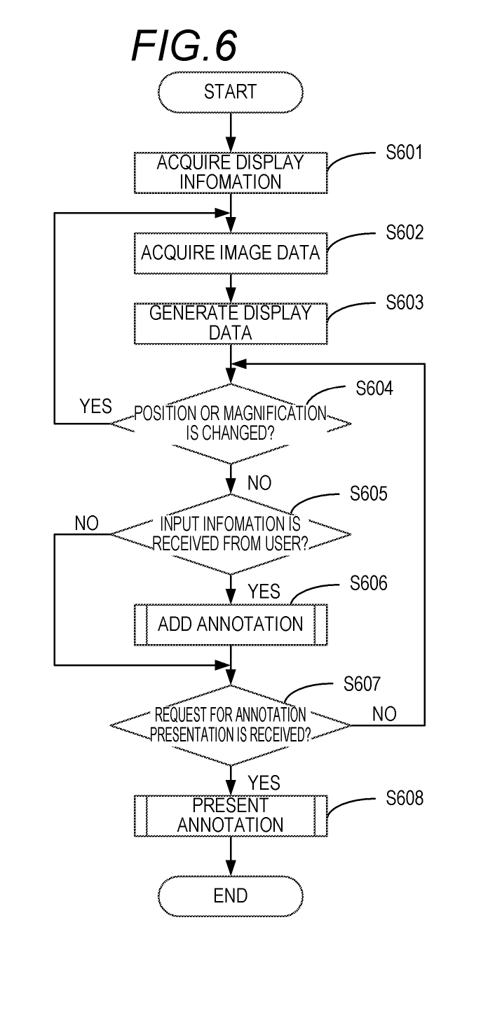

The resolution conversion processing unit 215 performs processing for generating a magnification image corresponding to a display magnification using resolution conversion in advance in order to quickly display a large volume two-dimensional image generated by the image combination processing unit 214. The resolution conversion processing unit 215 generates image data at a plurality of stages from a low magnification to a high magnification and forms the image data as image data having a combined hierarchical structure. Details are explained below with reference to FIG. 5.

The filter processing unit 216 is a digital filter that realizes suppression of a high-frequency component included in an image, noise removal, and sense of resolution enhancement. According to a gradation representation characteristic of a general display device, a gamma correction unit 217 executes processing for adding an inverse characteristic to an image or executes gradation conversion adjusted to a human visual sense characteristic through gradation compression or dark space processing of a high brightness part. In this embodiment, for image acquisition for the purpose of a form observation, gradation conversion suitable of combination processing and display processing at a later stage is applied to image data.

The compression processing unit 218 performs encoding processing of compression performed for the purpose of efficiency of transfer of large volume two-dimensional image data and a volume reduction during storage of the image data. As a compression method for a still image, standardized encoding systems such as JPEG (Joint Photographic Experts Group), JPEG 2000 and JPEG XR, which are improved and advanced versions of JPEG, and the like are widely generally known.

The pre-measuring unit 220 is a unit that performs prior measurement for calculating position information of the specimen on the slide 206, distance information to a desired focus position, and a parameter for light amount adjustment due to the thickness of the specimen. It is possible to carry out wasteless image pickup by acquiring information using the pre-measuring unit 220 before actual measurement (acquisition of picked-up image data). For acquisition of position information of a two-dimensional plane, a two-dimensional image sensor having resolution lower than the resolution of the image sensor 208 is used. The pre-measuring unit 220 grasps the position of the specimen on the XY plane from the acquired image. For acquisition of distance information and thickness information, a laser displacement meter or a measuring device of a Shack Hartmann type is used.

The main control system 221 has a function of performing control of the various units explained above. The control functions of the main control system 221 and the development processing unit 219 are realized by a control circuit including a CPU, a ROM, and a RAM. Specifically, a program and data are stored in the ROM. The CPU executes the program using the RAM as a work memory, whereby the functions of main control system 221 and the development processing unit 219 are realized. As the ROM, a device such as an EEPROM or a flash memory is used. As the RAM, a DRAM device such as a DDR3 is used. The function of the development processing unit 219 may be replaced with a function of a unit formed as an ASIC as a dedicated hardware device.

The data output unit 222 is an interface for sending RGB color images generated by the development processing unit 219 to the image processing apparatus 102. The imaging apparatus 101 and the image processing apparatus 102 are connected by a cable for optical communication. Alternatively, a general-purpose interface such as a USB or a Gigabite Ethernet (registered trademark) is used.

(Functional Configuration of the Image Processing Apparatus)

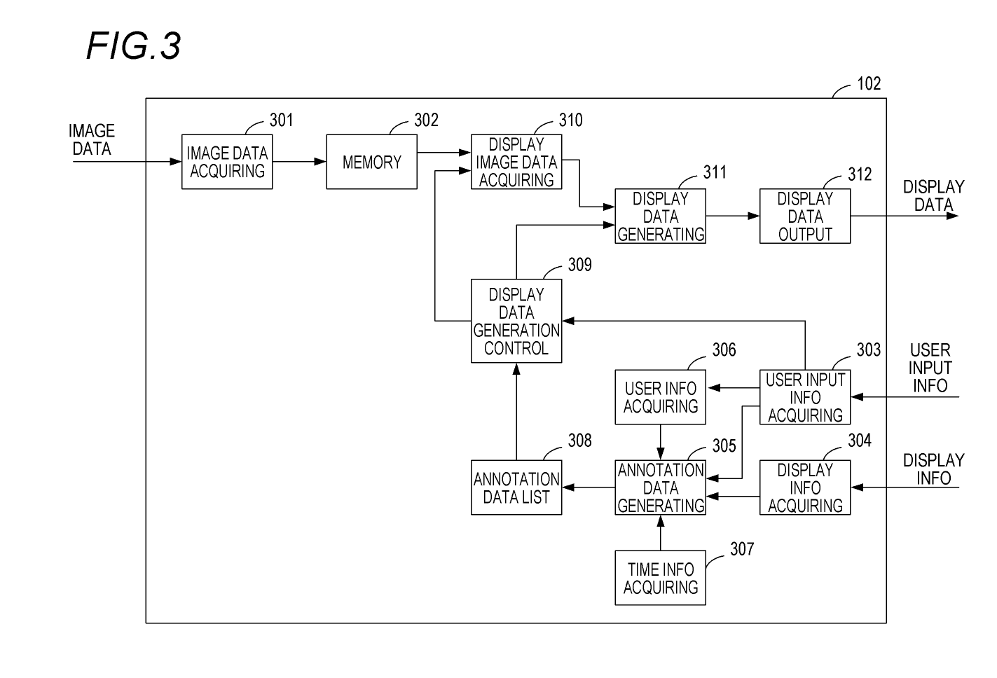

FIG. 3 is a block diagram showing a functional configuration of the image processing apparatus 102 according to this embodiment.

The image processing apparatus 102 schematically includes an image-data acquiring unit 301, a storing and retaining unit (a memory) 302, a user-input-information acquiring unit 303, a display-apparatus-information acquiring unit 304, an annotation-data generating unit 305, a user-information acquiring unit 306, a time-information acquiring unit 307, an annotation data list 308, a display-data-generation control unit 309, a display-image-data acquiring unit 310, a display-data generating unit 311, and a display-data output unit 312.

The image-data acquiring unit 301 acquires image data picked up by the imaging apparatus 101. The image data is at least any one of divided image data of the RGB colors obtained by dividing and picking up images of a specimen, one two-dimensional image data obtained by combining the divided image data, and image data layered for each display magnification on the basis of the two-dimensional image data. The divided image data may be monochrome image data.

The storing and retaining unit 302 captures image data acquired from an external apparatus via the image-data acquiring unit 301 and stores and retains the image data.

The user-input-information acquiring unit 303 acquires, via the operation unit such as the mouse or the keyboard, input information to a display application used in performing an image diagnosis. As operation of the display application, there are, for example, an update instruction for display image data such as a display position change or enlarged or reduced display and addition of an annotation, which is a note, to a region of interest. The user-input-information acquiring unit 303 acquires registration information of a user and a user selection result during an image diagnosis.

The display-apparatus-information acquiring unit 304 acquires information concerning a display magnification of a currently-displayed image besides display area information (screen resolution) of the display included in the display apparatus 103.

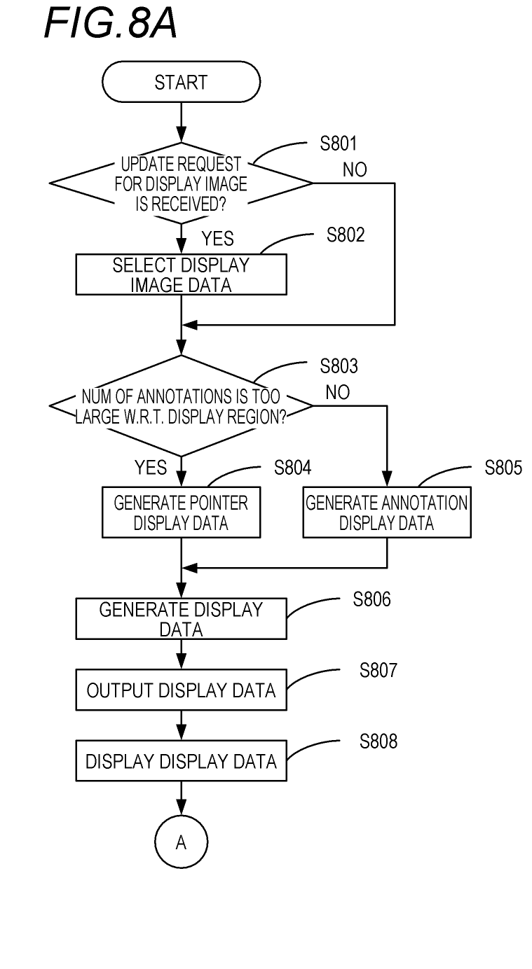

The annotation-data generating unit 305 generates, as an annotation data list, a position coordinate in an overall image, a display magnification, text information added as an annotation, and user information, which is a characteristic of this embodiment. For the generation of the list, position information in a display screen, display magnification information, text input information added as an annotation, user information explained below, and information concerning time when the annotation is added, which are acquired by the user-input-information acquiring unit 303 or the display-apparatus-information acquiring unit 304, are used. Details are explained below with reference to FIG. 7.

The user-information acquiring unit 306 acquires user information for identifying a user who adds an annotation. The user information is determined according to a login ID to a display application for viewing a diagnosis image running on the image processing apparatus 102. Alternatively, the user information can be acquired by selecting a user from user information registered in advance.

The time-information acquiring unit 307 acquires data and time when the annotation is added from a clock included in the image processing apparatus 102 or a clock on a network as date and time information.

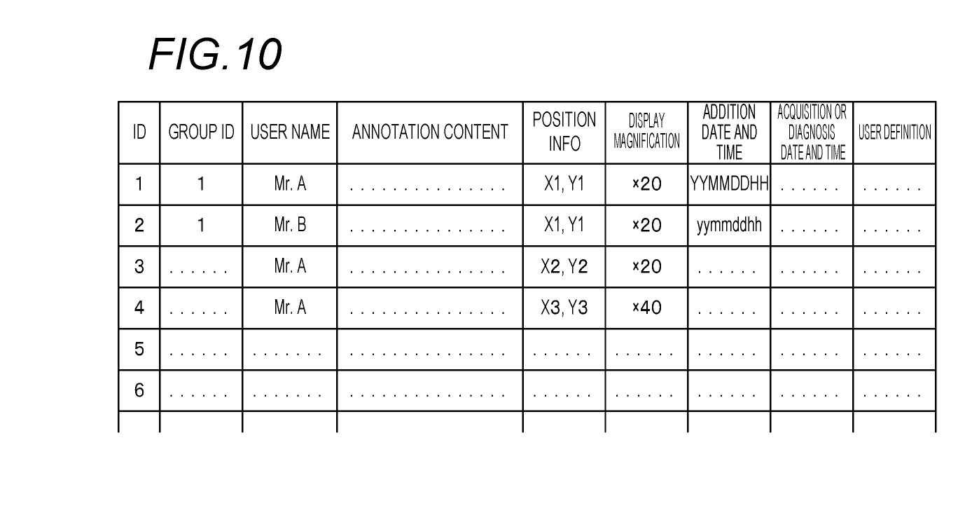

The annotation data list 308 is a reference table obtained by listing various kinds of information of the annotation generated by the annotation-data generating unit 305. The configuration of the list is explained with reference to FIG. 10.

The display-data-generation control unit 309 is a display control unit for controlling generation of display data according to an instruction from the user acquired by the user-input-information acquiring unit 303. The display data mainly includes image data and annotation display data.

The display-image-data acquiring unit 310 acquires image data necessary for display from the storing and retaining unit 302 according to the control by the display-data-generation control unit 309.

The display-data generating unit 311 generates display data for display on the display apparatus 103 using the annotation data list 308 generated by the annotation-data generating unit 305 and the image data acquired by the display-image-data acquiring unit 310.

The display-data output unit 312 outputs the display data generated by the display-data generating unit 311 to the display apparatus 103, which is an external apparatus.

(Hardware Configuration of the Image Processing Apparatus)

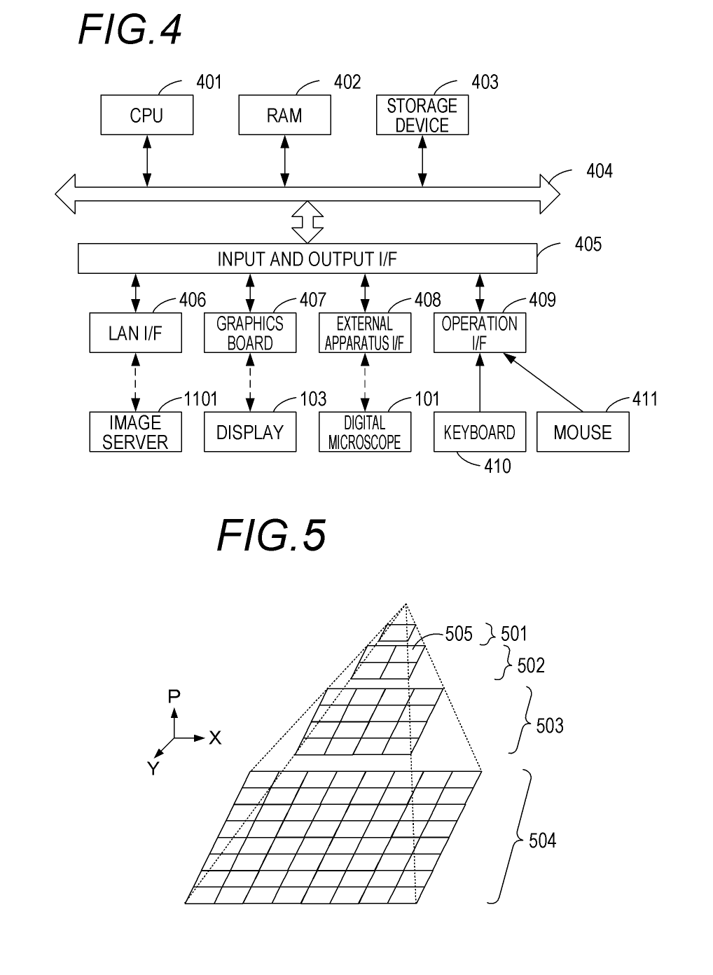

FIG. 4 is a block diagram showing a hardware configuration of the image processing apparatus 102 according to this embodiment. As an apparatus that performs information processing, for example, a PC (Personal Computer) is used.

The PC includes a CPU (Central Processing Unit) 401, a RAM (Random Access Memory) 402, a storage device 403, a data input and output I/F 405, and an internal bus 404 configured to connect these devices.

The CPU 401 accesses the RAM 402 and the like as appropriate according to necessity and collectively controls all blocks of the PC while performing various kinds of arithmetic processing. The RAM 402 is used as a work region or the like of the CPU 401. The RAM 402 temporarily stores an OS, various programs being executed, and various data to be processed by processing such as user identification for an annotation and generation of data for display, which are characteristics of this embodiment. The storage device 403 is an auxiliary storage device that records and reads out information in which the OS, programs, and firmware such as various parameters to be executed by the CPU 401 are fixedly stored. As the storage device 403, a magnetic disk drive such as a HDD (Hard Disk Drive) or an SSD (Solid State Disk) or a semiconductor device including a flash memory is used.

An image server 1101 is connected to the data input and output I/F 405 via a LAN I/F 406. The display device 103 is connected via a graphics board 407, the imaging apparatus 101 represented by a virtual slide apparatus and a digital microscope is connected via an external apparatus I/F 408, and a keyboard 410 and a mouse 411 are connected via an operation I/F 409.

The display apparatus 103 is a display device including, for example, a liquid crystal, an EL (Electro-Luminescence), or a CRT (Cathode Ray Tube). As the display device 103, a force connected as the external apparatus is assumed. However, a PC integrated with a display apparatus may be assumed. For example, a notebook PC corresponds to the PC.

As a connection device to the operation I/F 409, a pointing device such as the keyboard 410 or the mouse 411 is assumed. However, it is also possible to adopt a configuration in which a screen of the display apparatus 103 such as a touch panel is directly used as an input device. In that case, the touch panel can be integrated with the display apparatus 103.

(Concept of a Hierarchical Image Prepared for Each of Magnifications)

FIG. 5 is a conceptual diagram of a hierarchical image prepared in advance for each of different magnifications. The hierarchical image is an image set including a plurality of two-dimensional images of the same object (the same image content) and is an image set, the resolutions of which are varied step wise from low resolution to high resolution. A hierarchical image generated by the resolution-conversion processing unit 215 of the imaging apparatus 101 according to this embodiment is explained.

Reference numerals 501, 502, 503, and 504 respectively denote two-dimensional images having different resolutions prepared according to display magnifications. For simplification of explanation, the resolutions are resolutions in the one-dimensional direction, i.e., the resolution of a hierarchical image of 503 is a half of the resolution of 504, the resolution of a hierarchical image of 502 is a half of the resolution of 503, and the resolution of a hierarchical image of 501 is a half of the resolution of 502.

The image data acquired by the imaging apparatus 101 is desired to be image pickup data having high resolution and high resolving power for the purpose of diagnosis. However, as explained above, when a reduced image of image data including several billion pixels is displayed, processing is late if resolution conversion is performed every time according to a request for display. Therefore, it is desirable to prepare hierarchical images at several stages having different magnifications in advance, select, from the prepared hierarchical images, image data having a magnification close to a display magnification according to a request from a display side, and perform adjustment of the magnification according to the display magnification. In general, in terms of image quality, it is desirable to generate display data from image data having a higher magnification.

Since image pickup is performed at high resolution, hierarchical image data for display is generated by reducing image data having highest resolution using a resolution converting method. As a method of resolution conversion, for example, bicubic employing a tertiary interpolation formula is widely known besides bilinear, which is two-dimensional linear interpolation processing.

Image data of layers have two-dimensional axes X and Y. P shown as an axis in a direction orthogonal to XY is plotted from the configuration of a layered pyramid form.

Reference numeral 505 denotes divided image data in one hierarchical image 502. In the first place, generation of two-dimensional image data is performed by joining dividedly picked-up image data. As the divided image data 505, data in a range that can be picked up at a time by the image sensor 208 is assumed. Image data as a result of division of image data acquired in one image pickup or joining of an arbitrary number of image data may be set as a defined size of the divided image data 505.

Image data for pathology assumed to be diagnosis or observation target at different display magnifications such as enlargement and reduction is desirably generated and retained as a hierarchical image as shown in FIG. 5. Hierarchical image data may be collected and treated as one image data or may be respectively prepared as independent image data to retain information clearly indicating a relation with a display magnification. In the following explanation, it is assumed that the hierarchical image data is single image data.

(Method of Addition and Presentation of an Annotation)

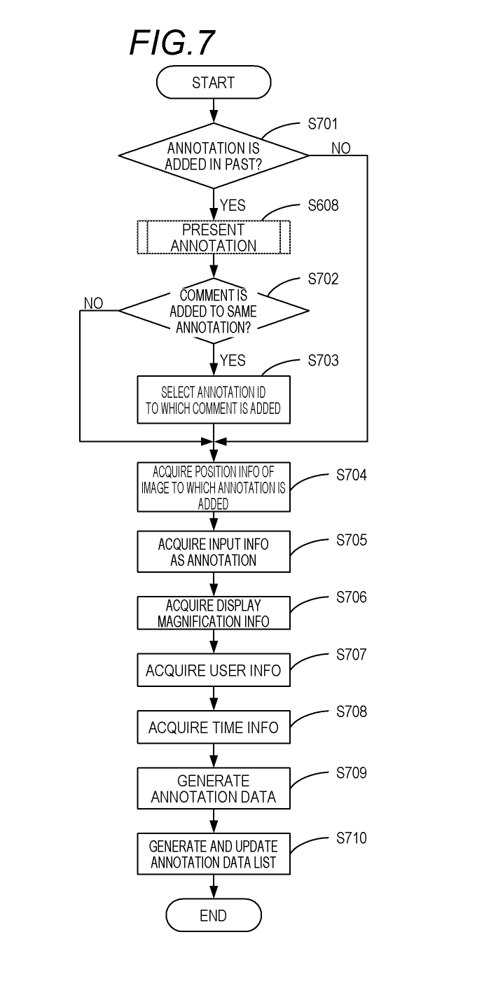

A flow of addition and presentation of an annotation in the image processing apparatus 102 according to this embodiment is explained with reference to a flowchart of FIG. 6.

In step S601, the display-apparatus-information acquiring unit 304 acquires information concerning a display magnification of a currently-displayed image besides size information (screen resolution) of a display area of the display apparatus 103. The size information of the display area is used for determining a size of image data to be generated. The display magnification is used when any image data is selected from hierarchical images and when an annotation data list is generated. Information collected as a list is explained below.

In step S602, the display-image-data acquiring unit 310 acquires, from the storing and retaining unit 302, image data corresponding to the display magnification of the image currently displayed on the display apparatus 103 (or a defined magnification at an initial stage).

In step S603, the display-data generating unit 311 generates, on the basis of the acquired image data, display data to be displayed on the display apparatus 103. When the display magnification is different from the magnification of the acquired hierarchical image, processing for resolution conversion is performed. The generated image data is displayed on the display apparatus 103.

In step S604, the display-data-generation control unit 309 determines, on the basis of user input information, whether update of a displayed screen is performed according to an instruction from the user. Specifically, there is a change of the display magnification besides a change of a display position for displaying image data present on the outer side of the displayed screen. When the screen update is necessary, the processing returns to step S602 and processing for acquisition of image data and screen update by generation of display data is performed. When the screen update is not requested, the processing proceeds to step S605.

In step S605, the display-data-generation control unit 309 determines, on the basis of the user input information, whether an instruction or a request for annotation addition is received from the user. When the annotation addition is instructed, the processing proceeds to step S606. When the annotation addition is not instructed, the processing proceeds to step S607 skipping processing for the annotation addition.

In step S606, various kinds of processing involved in addition of an annotation is performed. Examples of processing contents include link to user information and comment addition to the same (existing) annotation, which are characteristics of this embodiment, besides storage of an annotation content (comment) input by the keyboard 410 or the like. Details are explained below with reference to FIG. 7.

In step S607, the display-data-generation control unit 309 determines whether presentation of the added annotation is requested. When the presentation of the annotation is requested by the user, the processing proceeds to step S608. When the presentation is not requested, the processing returns to step S604 and the processing in step S604 and subsequent steps is repeated. The processing is explained in time series because of the explanation of the flow. However, the reception of the screen update request, which is the change of the display position and the magnification, the annotation addition, and the annotation presentation may at any timing including simultaneous, sequential, and the like.

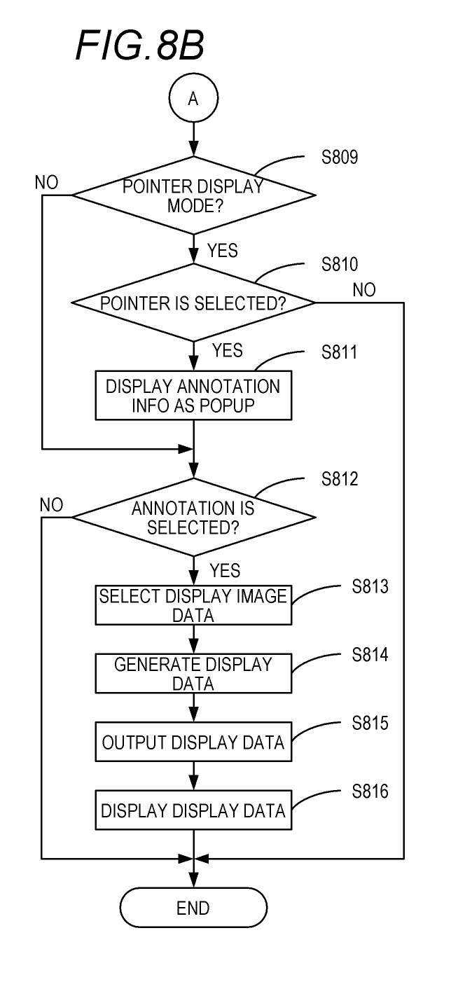

In step S608, the display-data-generation control unit 309 performs, in response to the request for presentation, processing for effectively presenting the annotation to the user. Details are explained below with reference to FIGS. 8A and 8B.

(Addition of an Annotation)

FIG. 7 is a flowchart for explaining a detailed flow of the processing for adding an annotation explained in step S606 in FIG. 6. In FIG. 7, a flow for generating annotation data on the basis of position information and a display magnification of an image to which an annotation is added and user information is explained.

In step S701, the display-data-generation control unit 309 determines whether an annotation is added to image data set as a diagnosis target. When an annotation has already been added, the processing proceeds to step S608. When an annotation is added for the first time, the processing proceeds to step S704 skipping steps. A situation in which an annotation has already been added to image data to be referred to includes a situation in which an opinion for the same specimen is requested by another user and a situation in which the same user confirms various diagnosis contents including an annotation once added.

In step S608, the display-data-generation control unit 309 presents the annotation added in the past to the user. Details of the processing are explained below with reference to FIGS. 8A and 8B.

In step S702, the display-data-generation control unit 309 determines whether operation by the user is update or new addition of comment contents for any presented annotation or addition of a new annotation. When comment addition or correction for the same (i.e., existing) annotation is performed, in step S703, the annotation-data generating unit 305 grasps and selects an ID number of an annotation for which a command is added or corrected. Otherwise, i.e., when addition of a new annotation for a different region of interest is performed, the processing proceeds to step S704 skipping the processing in step S703.

In step S704, the annotation-data generating unit 305 acquires position information of an image to which the annotation is added. Information acquired from the display apparatus 103 is relative position information in a display image. Therefore, the annotation-data generating unit 305 performs processing for converting the information into the position of the entire image data stored in the storing and retaining unit 302 to grasp a coordinate of an absolute position.

Absolute position information in the image to which the annotation is added is obtained by calculating a correspondence relation between the position to which the annotation is added and a display magnification for each of hierarchical images such that even hierarchical image data having different magnification data can be used. For example, it is assumed that an annotation is added to the position of a point P (100, 100) where distances (pixels) from an image origin (X=Y=0) are respectively 100 pixels at a display magnification of 20. In a high magnification image having a magnification of 40, a coordinate where the annotation is added is P1 (200, 200). In a low magnification image having a magnification of 10, a coordinate where the annotation is added is P2 (50, 50). For simplification of explanation, convenient display magnifications are used. However, when a display magnification is, for example, 25, in a high magnification image having a magnification of 40, a coordinate where the annotation is added is P3 (160, 160). In this way, a value of a coordinate only has to be multiplied with a ratio of a magnification of a hierarchical image to be acquired and a display magnification.

In step S705, the user-input-information acquiring unit 303 acquires an annotation content (text information) input by the keyword 410. The acquired text information is used in annotation presentation.

In step S706, the display-apparatus-information acquiring unit 304 acquires a display magnification of an image displayed on the display apparatus 103. The display magnification is a magnification during observation at the time when the annotation addition is instructed. The display magnification information is acquired from the display apparatus 103. However, since the image processing apparatus 102 generates image data, data of a display magnification stored in the image processing apparatus 102 may be used.

In step S707, the user-information acquiring unit 306 acquires various kinds of information concerning the user who adds the annotation.

In step S708, the time-information acquiring unit 307 acquires information concerning the time when the annotation addition is instructed. The time-information acquiring unit 307 may acquire incidental date and time information such as date and time of diagnosis and observation together with the time information.

In step S709, the annotation-data generating unit 305 generates annotation data on the basis of the position information acquired in step S704, text information acquired in step S705, the display magnification acquired in step S706, the user information acquired in step S707, and the date and time information acquired in step S708.

In step S710, when the addition of the annotation data is performed for the first time, the annotation-data generating unit 305 creates an annotation data list anew on the basis of the annotation data generated in step S709. When a list is already present, the annotation-data generating unit 305 updates values and contents of the list on the basis of the annotation data. Information stored in the list is the position information, to which the annotation is added for each of the hierarchical images, generated in step S704, actually, position information converted for each of the hierarchical images having the respective magnifications, a display magnification to be added, text information input as the annotation, a user name, and date and time information. The configuration of the annotation data list is explained below with reference to FIG. 10.

(Presentation of the Annotation)

FIGS. 8A and 8B shows a flowchart for explaining a detailed flow of the processing for presenting the annotation (S608 in FIGS. 6 and 7). In FIGS. 8A and 8B, a flow for generating display data for presenting the annotation on the basis of the annotation data list is explained.

In step S801, the display-data-generation control unit 309 determines whether an update request for a display screen is received from the user. In general, it is predicted that a display magnification (about 5 to 10) in screening for comprehensively observing entire image data, a display magnification (20 to 40) in detailed observation, and a display magnification for checking a position where an annotation is added are different. Therefore, the display-data-generation control unit 309 determines, on the basis of an instruction of the user, whether a display magnification suitable for annotation presentation is selected. Alternatively, a display magnification may be automatically set from a range in which the annotation is added. When the update of the display screen is necessary, the processing proceeds to step S802. When the update of the display screen is not requested, the processing proceeds to step S803 skipping update processing.

In step S802, the display-image-data acquiring unit 310 selects display image data suitable for the annotation presentation in response to the update request for the display screen. For example, when a plurality of annotations are added, the display-image-data acquiring unit 310 determines a size of a display region such that at least a region including the plurality of annotations is displayed. The display-image-data acquiring unit 310 selects image data having desired resolution (magnification) out of hierarchical image data on the basis of the determined size of the display region.

In step S803, it is determined whether the number of annotations added to the display region of the display screen is larger. A threshold used for the determination can be arbitrarily set. The display-image-data acquiring unit 310 may be configured to be capable of selecting an annotation display mode and a pointer display mode explained below according to an intension of the user. The display mode is switched according to the number of annotations because, when the number of annotations added to the display region of the screen is too large, it is difficult to observe an image for diagnosis on the background. When an annotation content is displayed on the screen at a ratio equal to or higher than a fixed ratio, it is desirable to adopt the pointer display mode. The pointer display mode is a mode for showing only position information where annotations are added on the screen using icons, flags, or the like. The annotation display mode is a mode for displaying an annotation content input as a comment on the screen. When the pointer display mode is selected and adopted, the processing proceeds to step S804. When the annotation display mode is selected and adopted, the processing proceeds to step S805.

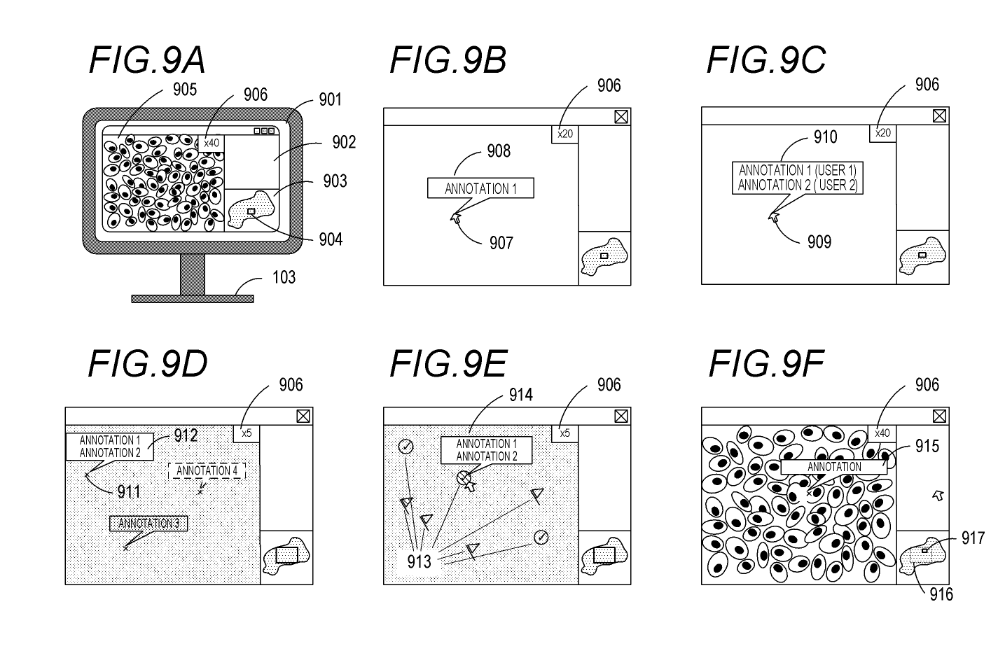

In step S804 (the pointer display mode), the display-data generating unit 311 generates data for indicating the positions of the annotations as pointers such as icons. At this point, a type, a color, and a presentation method of the icons of the points can be changed according to, for example, a difference of a user who adds the annotations. A screen example of the pointer display is explained below with reference to FIG. 9E.

In step S805 (the annotation display mode), the display-data generating unit 311 generates data for displaying, as a text, contents added as an annotation. In order to perform identification of a user, a color of characters, which are comment contents, of the annotation to be displayed is changed for each of users. Besides changing the character color, any method such as changing a color and a shape of an annotation frame or blinking display or transparent display of the annotation itself may be used as long as the user who adds the annotation can be identified. A screen example of the annotation display is explained below with reference to FIG. 9D.

In step S806, the display-data generating unit 311 generate display data for screen display on the basis of the selected display image data and annotation display data generated in step S804 or step S805.

In step S807, the display-data output unit 312 outputs the display data generated in step S806 to the display apparatus 103.

In step S808, the display apparatus 103 updates the display screen on the basis of the output display data.

In step S809, the display-data-generation control unit 309 determines whether the current display mode is the annotation display mode or the pointer display mode. When the current display mode is the pointer display mode, the processing proceeds to step S810. When the current display mode is the annotation display mode, the processing proceeds to step S812 skipping steps.

In step S810 (the pointer display mode), the display-data-generation control unit 309 determines whether the user selects a point displayed on the screen or places a mouse cursor on the pointer. In the annotation display mode, contents of a text input as an annotation is displayed on the screen. In the pointer display mode, an annotation content is displayed according to necessity. When the pointer is selected or the mouse cursor is placed on the pointer, the processing proceeds to step S811. When the pointer is not selected, the processing for the annotation presentation is ended.

In step S811, the display-data-generation control unit 309 performs control to display, as popup, text contents of the annotation added to the position of the selected pointer. In the case of the popup processing, when the selection of the pointer is released, the display of the annotation content is stopped. Once selected, the annotation content may continue to be displayed on the screen until an instruction is issued.

In step S812, the display-data-generation control unit 309 determines whether an annotation is selected. According to the selection of an annotation, a display magnification and a display position at the time when the annotation is added are reproduced. When an annotation is selected, the processing proceeds to step S813. When an annotation is not selected, the processing for the annotation presentation is ended.

In step S813, the display-image-data acquiring unit 310 selects display image data on the basis of an instruction from the display-data-generation control unit 309. The display image data to be selected is selected on the basis of the position information and the display magnification during the annotation addition stored in the annotation data list.

In step S814, the display-data generating unit 311 generates display data on the basis of the annotation selected in step S812 and the display image data selected in step S813.

Output of the display data in step S815 and screen display of the display data on the display apparatus 103 in step S816 are respectively the same as step S807 and step S808. Therefore, explanation of the steps S815 and S816 is omitted.

(Display Screen Layout)

FIGS. 9A to 9F are an example of a display screen displayed when display data generated by the image processing apparatus 102 according to this embodiment is displayed on the display apparatus 103. A display screen during annotation addition, the pointer display mode and the annotation display mode, and reproduction of an image display position and a display magnification at the time when an annotation is added are explained.

FIG. 9A is a basic configuration of a screen layout of the display apparatus 103. In the display screen, an information area 902 indicating information concerning statuses of display and operation and various images, a thumbnail image 903 of an observation target, and a display region 905 of specimen image data for detailed observation are arranged in an entire window 901. In the thumbnail image 903, a detail display region 904 indicating an area (a detail observation area) displayed in the display region 905 is displayed. In the display region 905, a display magnification 906 of an image displayed in the display region 905 is displayed. The regions and the images may be displayed in a form in which a display region of the entire window 901 is divided for each of function regions by a single document interface or a form in which the respective regions are formed by different windows by a multi-document interface. The thumbnail image 903 displays the position and the size of the display region 905 of specimen image data in an overall image of a specimen. The position and the size can be grasped according to a frame of the detail display region 904. For example, the detail display region 904 can be directly set according to a user instruction from an externally-connected input device such as a touch panel or the mouse 411 or can be set and updated according to movement and enlargement and reduction operation of a display region with respect to a displayed image. In the display region 905 of the specimen image data, specimen image data for detailed observation is displayed. An enlarged or reduced image of an image by movement of the display region (selection and movement of an observation target partial region from a specimen overall image) and a change of a display magnification are displayed according to an operation instruction from the user.

FIG. 9B is an example of an operation screen displayed when an annotation is added. It is assumed that the display magnification 906 is set to 20. The user can select a region of interest (or a position of interest) on an image in the display region 905 and add a new annotation. The region of interest or the position of interest is a region or a position that the user determines as a portion that should be paid attention in the image. For example, in the case of image diagnosis, a portion where abnormality appears, a portion where detailed observation is necessary, or a portion for which some opinion is present is designated as the region of interest or the position of interest. A new annotation is added by operation for, after designating a position on an image with the mouse 411, shifting to the annotation input mode and inputting a text (an annotation content) with the keyboard 410. FIG. 9B shows a state in which an annotation 908 is added to the position of a mouse cursor 907. An annotation content (also referred to as comment) “annotation 1” is input to the annotation 908. The position information of the annotation and the annotation content are stored in association with a value of the display magnification (906) of an image of the display region 905 at that point.

FIG. 9C is an example of an operation screen displayed when an annotation is added in the same position as the existing annotation. An example in which, after the annotation 1 shown in FIG. 9B is added by a certain user, another user adds an annotation 2 in the same position of the same image data is explained. The other user can select an arbitrary annotation out of screen-displayed annotations and add a comment to the annotation (i.e., a region of interest or a position of interest to which the annotation is already added). Reference numeral 909 in FIG. 9C denotes a point (a position) to which the annotation 1 is added in FIG. 9B. Reference numeral 910 denotes a state in which the annotation 2 is added to the annotation 1. In this way, comments of addition and correction can be inserted in the same region of interest (position of interest).

When a plurality of comments are added to the same region of interest (position of interest), it is advisable to perform screen display using information concerning users to make it possible to easily identify which user inputs which annotation (comment). Further, it is more advisable to perform screen display to make it possible to easily identify, on the basis of information concerning date and time when annotations are added, when the annotations are added or in which order the annotations are added. As a specific method of realizing the identification of the users and the identification of the date and time, a method of varying a display form of the annotations is desirable. In FIG. 9C, an example in which a plurality of annotations added to the same region of interest (position of interest) are grouped and displayed in one annotation frame is shown. However, a form for displaying the respective annotations in separate annotation frames may be adopted. In the former case, it looks as if a plurality of comments are listed in one annotation. In the latter case, it looks as if a plurality of annotations are added in the same position. However, in the latter case, it is advisable to use an annotation frame of the same form for the annotations in the same positions to make it possible to easily distinguish a group of the annotations. The annotations belonging to the same group are desirably displayed in time order (in order from the oldest one or in order from the latest one) on the basis of date and time of addition. Consequently, it is easy to compare and refer to diagnosis opinions for a plurality of users concerning points of attention and grasp transition of comments in time series.

As the method of varying a display form of the annotation for each of the users, various methods can be adopted. For example, (1) a change of a representation method of a text, which is an annotation content, (2) a change of an annotation frame, and (3) a method of displaying an entire annotation are assumed. (1) A change of a representation method of a text is a method of varying, for each of the users, a color, brightness, a size, a type of a font, and decoration (boldface, italic) of a text, a color and a pattern of the background of the text, and the like. As shown in FIG. 9C, there is also a method of displaying a name and an ID of a user for each of annotations. (2) The change of an annotation frame is a method of varying, for each of the users, a color, a line type (solid line, broken line), and a shape (balloon, selection of a shape other than a rectangle) of a frame, a color and a pattern of the background, and the like. (3) The method of displaying an entire annotation is a method of varying, for each of the users, a way of performing, for example, alpha blending (transparent image display) with image data, which is a background image, displayed in the display region 905 and blinking display of the annotation itself. The variations of the display forms explained above are examples. The display forms may be combined and display forms other than these forms may be used.

When a display form of annotations is varied for each date and time, methods same as (1) to (3) explained above can be used. However, when a display form is changed on the basis of date and time, for example, it is advisable to categorize the annotations in a predetermined period unit such as time, a period of time, day, week, or month and vary the display form for each of the annotations added in different periods. The display form may be changed little by little in time order (in order from the oldest one or in order from the latest one), for example, a color and brightness of the annotations are changed stepwise. Consequently, it is possible to easily grasp a time series of the annotation from the change of the display form.

FIG. 9D is an example of screen display of the annotation display mode. An example in which four annotations are added in three places in an image is shown. Reference numeral 911 denotes a point where the annotations 1 and 2 are added and 912 denotes contents of the annotations. When annotations are added in a plurality of positions in an image, the display magnification of the display region 905 is adjusted to make it possible to display the positions of all the annotations. An example in which an image is displayed at a low display magnification of 5 is shown. In this display screen, it is advisable to vary a display form of the annotations according to a display magnification at the time when the annotations are added. For example, it is assumed that the annotations 1, 2, and 3 are added to a display image having a display magnification of 20 and an annotation 4 is added to a display image having a display magnification of 40. In this case, when display forms of the annotations are different as shown in FIG. 9D, it is easily distinguish that display magnifications at the time when the annotations are added are different. The annotations 1, 2, and 3 have the same display magnification (20). However, since the annotations 1 and 2 belong to an annotation group for the same place, a display form of the annotations 1 and 2 is changed from a display form of the annotation 3. A point where a plurality of annotations are added can be regarded as a point in which a user has a high interest. Therefore, as shown in FIG. 9D, it is desirable to change a display form of the annotations when only one annotation is added and when a plurality of annotations are added in the same point. It is advisable to adopt a display form that is more conspicuous (attract more attention of the user) when the number of annotations added in the same point is larger.

FIG. 9E is a screen display example displayed when annotations are displayed in the pointer display mode. When a large number of annotations are added to one image, when the annotations are displayed in the annotation display mode, a large portion of the image is hidden by the annotations and the annotations are confusing because there are too many annotations. As a result, observation is hindered. The pointer display mode is a mode for hiding contents of annotations and clearly showing only a relation between position information where the annotations are added and a display magnification using a pointer. Consequently, it is possible to easily select a desired annotation out of the large number of annotations added to the image. Reference numeral 913 denotes an icon image (also referred to as flag or pointer) indicating a position where an annotation is added and 914 denotes an example in which annotation contents are displayed as popup when an icon image is selected.

FIG. 9F is a display example of a screen in which a display position and a display magnification in an image at the time when an annotation is added are reproduced. When a desired annotation is selected in the annotation display mode or the pointer display mode, the display-data-generation control unit 309 specifies, referring to the annotation data list, a display magnification and a display position in an image at the time when the annotation is added and generates and displays display data at the same display magnification and in the same position. A positional relation between the selected annotation and the overall image can be determined from a display frame 916 of the entire annotation in the thumbnail image 903 and a reproduction range 917 of the selected annotation.

(Example of the Annotation Data List)

FIG. 10 shows the configuration of the annotation data list generated by the image processing apparatus 102 according to this embodiment.

As shown in FIG. 10, information concerning annotations added to an image is stored in the annotation data list. One row of the list represents information concerning one annotation. ID numbers are allocated to the respective annotations in order in which the annotations are added. The respective kinds of annotation information include a group ID, a user name, annotation content, position information and a display magnification at the time of annotation addition, and date and time information when an annotation is added. The group ID is attribute information indicating an annotation is added to the same place shown in FIG. 9C. For example, annotations of ID 1 and ID 2 are added to the same place. Therefore, the annotations have the same group ID “1” and position information and display magnifications of the annotations are the same. When an annotation is added to a region of interest (a region having some breadth) rather than a position of interest (a point), information (e.g., a vertex coordinate of a polygonal region) defining a region rather than a coordinate value of the point only has to be recorded in the annotation data as position information. Main contents stored in the annotation data list are as explained above. However, other information including information necessary for search may be stored. Information concerning date and time when an image is acquired and date and time when the image is used for diagnosis, an item uniquely defined by the user, and the like may be able to be stored as annotation information. It is possible to reproduce an observation environment at the time when an annotation is added according to position information and a display magnification stored together.

(Effects of this Embodiment)

When an annotation is added, besides the storage of annotation content itself, user information is stored together and a correspondence relation between the annotation and the user information is prepared as a list. Therefore, when the annotation is presented, it is possible to easily identify a user who adds the annotation. As a result it is possible to provide an image processing apparatus that can reduce labor and time of a pathologist. In this embodiment, in particular, a plurality of annotations for the same place are collected. Therefore, it is possible to clearly present comparison of and reference to diagnosis opinions of a plurality of users for a point of attention and transition of comments in time series.

### Second Embodiment

An image processing system according to a second embodiment of the present invention is explained with reference to the drawings.

In the first embodiment, besides a portion where an annotation is added and a display magnification, user information is stored as a list to make it easy to identify a user when the annotation is presented to the user. In a second embodiment, not only annotations in the same place but also a plurality of annotations added to regions of interest in different places are grouped to make it possible to accurately present necessary information and focus efforts on diagnosis work. In the second embodiments, the components explained in the first embodiment can be used except components different from the components in the first embodiment.

In the explanation in the first embodiment, user information is acquired according to login information or selection by the user. However, in the second embodiment, addition of an annotation between users in remote places via a network is assumed. Besides the user information acquired in the first embodiment, for example, network information (an IP address, etc.) allocated to a computer connected to a network can also be used.

(Apparatus Configuration of the Image Processing System)

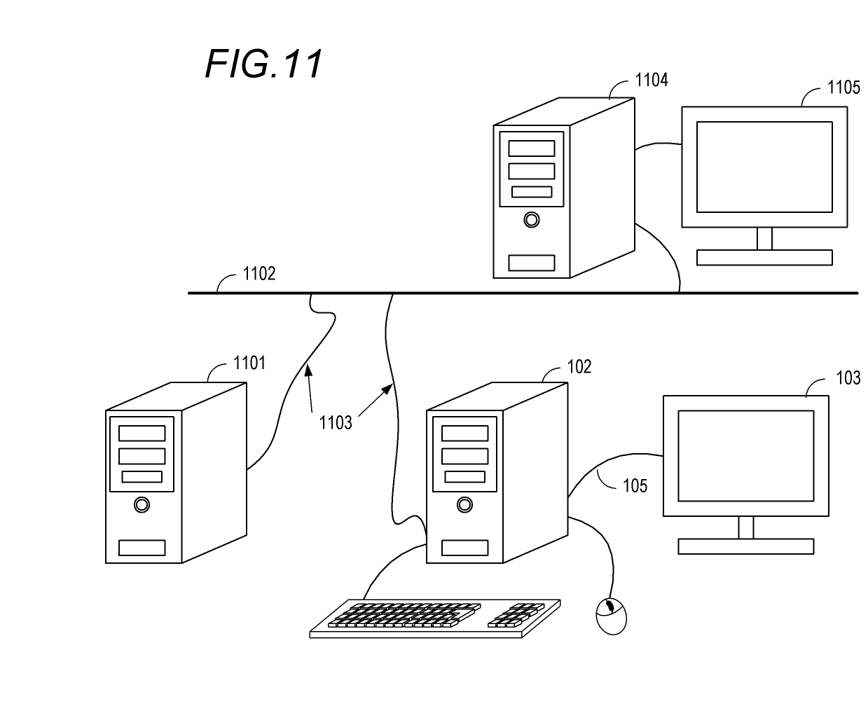

FIG. 11 is an overall view of apparatuses included in the image processing system according to the second embodiment of the present invention.

The image processing system according to this embodiment includes an image server 1101, the image processing apparatus 102, the display apparatus 103 connected to the image processing apparatus 102, an image processing apparatus 1104, and a display apparatus 1105 connected to the image processing apparatus 1104. The image server 1101, the image processing apparatus 102, and the image processing apparatus 1104 are connected via a network. The image processing apparatus 102 can acquire image data obtained by picking up an image of a specimen from the image server 1101 and generate image data to be displayed on the display apparatus 103. The image server 1101 and the image processing apparatus 102 are connected by a general-purpose I/F LAN cable 1103 via a network 1102. The image server 1101 is a computer including a lager-capacity storage device that stores image data picked up by the imaging apparatus 101, which is a virtual slide apparatus. The image server 1101 may store hierarchical image data having different display magnifications all together in a local storage connected to the image server 1101 or may divide the respective image data and separately include the entities of the divided image data and link information in a server group (cloud servers) present somewhere on the network. It is unnecessary to store the hierarchical image data in one server. The image processing apparatus 102 and the display apparatus 103 are the same as those of the image processing system according to the first embodiment. It is assumed that the image processing apparatus 1104 is present in a place (a remote place) distant from the image server 1101 and the image processing apparatus 102. A function of the image processing apparatus 1104 is the same as the function of the image processing apparatus 102. When different users use the image processing apparatuses 102 and 1104 and add annotations, added data are stored in the image server 1101. Consequently, it is possible to refer to image data and annotation contents from both the users.

In an example shown in FIG. 11, the image processing system includes the five apparatuses, i.e., the image server 1101, the image processing apparatuses 102 and 1104, and the display apparatuses 103 and 1105. However, the present invention is not limited to this configuration. For example, the image processing apparatuses 102 and 1104 integrated with the display apparatuses 103 and 1105 may be used. A part of the functions of the image processing apparatuses 102 and 1104 may be incorporated in the image server 1101. Conversely, the functions of the image server 1101 and the image processing apparatuses 102 and 1104 may be divided and realized by a plurality of apparatuses.

A configuration is assumed in which the different image processing apparatuses 102 and 1104 present in remote locations access image data added with an annotation stored in the image server 1101 and acquire the image data. However, the present invention can adopt a configuration in which one image processing apparatus (e.g., 102) locally stores the image data and other users access the image processing apparatus 102 from remote locations.

(Grouping of Annotations in a Region of Interest)

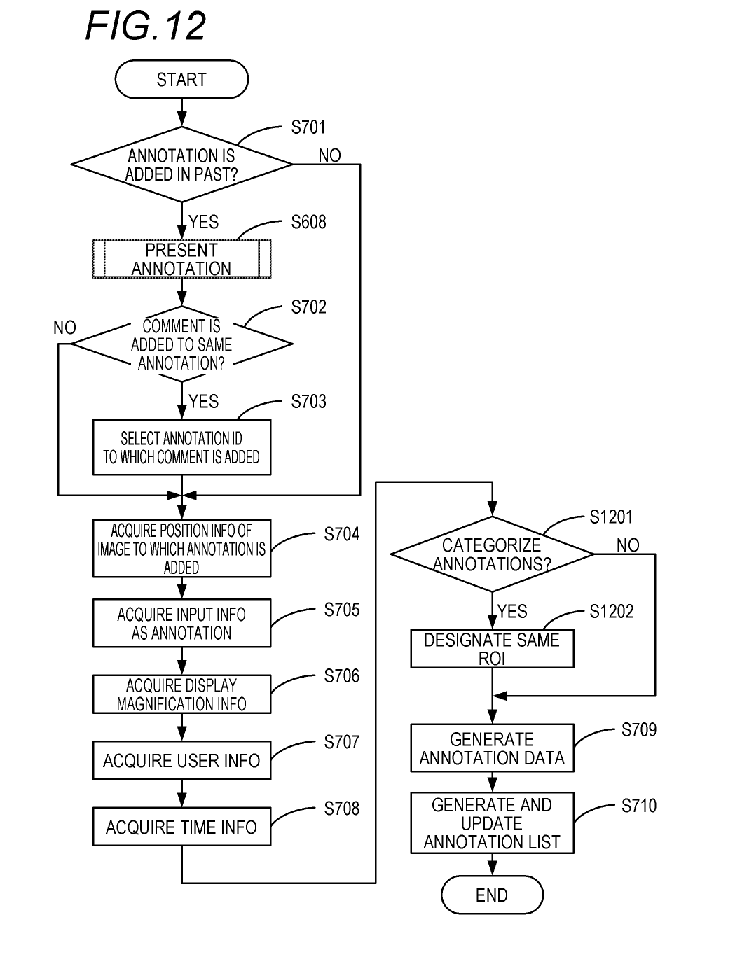

FIG. 12 is a flowchart for explaining a flow of processing obtained by adding a grouping function for the same region of interest, which is a characteristic of this embodiment, to the processing for adding an annotation explained with reference to FIG. 7 in the first embodiment. A process up to acquisition of various kinds of information of annotation addition is the same as the process in FIG. 7. Therefore, explanation of the same processing is omitted.

Processing contents of annotation addition from step S701 to step S710 are substantially the same as the contents explained with reference to FIG. 7 in the first embodiment. Before the generation processing for annotation data (S709), processing collecting annotations added to the same region of attention all together is added.

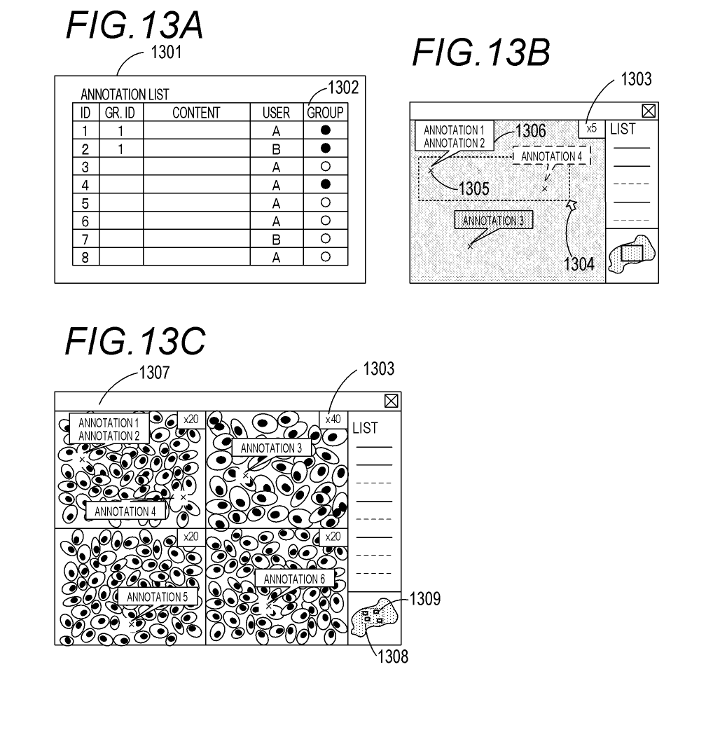

In step S1201, the user determines whether processing for collecting a plurality of annotations all together as related information in the same region of interest (called categorizing or grouping) is used. Concerning annotations for the same place, as explained in the first embodiment, a form of display is changed to make it possible to identify a type of a user, addition date and time, and the like and uniting processing for the annotation is performed. For example, the user determines whether a plurality of annotations added in a region of interest (a region to which a pathologist, who is the user, pays attention) displayed at an arbitrary magnification (in general, a high magnification equal to or higher than 20) are desirably collected all together as information for diagnosis. This is because not only indication of a malignant part but also diagnosis of the influence on peripheral tissues, comparison with a cell and a tissue considered to be normal, and the like are performed in multiple viewpoints on the basis of a plurality of kinds of information. When grouping of a plurality of annotations is performed, the user instructs execution of the grouping function using the mouse 411 or the like, whereby the processing proceeds to step S1202. When the grouping is not performed, the processing proceeds to step S709. A method for the grouping is explained below with reference to FIGS. 13A and 13B.

In step S1202, the annotation-data generating unit 305 (see FIG. 3) causes the user to designate annotations to be grouped. As a method for the designation, there are, for example, a method of selecting annotations out of a plurality of annotations presented as a list using check boxes and a method of designating a region to be grouped as a range with the mouse 411 or the like and selecting and designating annotations included in the range.

Processing for generation of annotation data in step S709 and generation and update of an annotation data list in step S710 is the same as the processing in the first embodiment. Therefore, explanation of the processing is omitted. A change from the first embodiment is that, when annotation data is generated, a group ID in the same region of interest is given in the same manner as the group ID in the same place is given and content of the group ID is stored in the list.

(Display Screen Layout)

FIG. 13 is an example of a display screen displayed when display data generated by the image processing apparatus 102 is displayed on the display apparatus 103. In FIG. 13, groping in the same region of attention and reproduction of a plurality of image display positions and display magnifications performed when annotation is added are explained.

FIG. 13A is an example of an annotation list displayed as a screen when annotations to be grouped are designated. An annotation list 1301 includes an ID number individually allocated, a group ID indicating a relation of a group of collected annotations in the same place, annotation content, a user name, and a check box 1302 for designating annotations to be grouped as related information. An example in which annotation IDs 1, 2, and 4 are selected is shown. The IDs 1 and 2 are originally grouped as annotations added to the same place. A group ID “1” is given to the IDs 1 and 2. It is assumed that a plurality of annotations can be selected using the check box 1302. It is also possible to prioritize items and perform sorting operation for a plurality of items. A configuration in which one grouping can be performed using a check box is explained. However, when a plurality of regions of interest are set, it is possible to cope with the regions of interest by allocating group IDs for the regions of interest.

FIG. 13B is an example of a display screen for performing the grouping operation shown in FIG. 13A by designating an area rather than from the list. In an example explained here, four annotations in three places including an annotation added to the same place are added. Reference numeral 1305 denotes a point (a position) where annotations are added and 1306 denotes contents of the added annotations. In 1303, it is indicated that this image has a display magnification of 5. A region of interested is designated by region designation using drag operation of the mouse 411. Reference numeral 1304 denotes a region of interest designated by the mouse 411. Annotations 1, 2, and 4 are selected and designated as related information in the same region of interest.

FIG. 13C is a display example of a screen in which a plurality of display places and display magnifications in an image at the time when annotations are added are reproduced. When desired annotations are selected in the annotation display mode and the pointer display mode, display magnifications and display positions in the image at the time when the annotations are added re respectively reproduced with reference to the annotation data list. In this example, six selected annotations in total are displayed. Among the six annotations, only a display magnification at the time of the annotation addition at the upper right is set to 40, which is different from other display magnifications. The difference among the display magnifications can also be clearly indicated by, for example, a change of a color of frames of the display regions 905 besides magnification display in the display magnification 1303. Three annotations are displayed in a display frame at the upper left as targets in the same region of interest. Reference numeral 1307 denotes display contents of the annotations.

A positional relation between the selected annotations and the entire image is displayed in the same manner as in the first embodiment. The positional relation can be determined from a display frame 1308 of the entire annotation in the thumbnail image 903 and a reproduction range 1309 of a plurality of selected annotations. A correspondence relation between the reproduction range 1309 and the display region 905 can be distinguished using a color, a line type, and the like of a frame line. By selecting an arbitrary display image in the display region 905 or the reproduction range 1309, it is also possible to shift to a display mode in which the entire display region 905 is used.

(Effects of this Embodiment)

A function of grouping not only annotations added to the same place but also annotations added to different places and presenting the annotations as relation information. Therefore, targets of attention are expanded from a point to a region. It is possible to clearly present comparison of and reference to diagnosis opinions of a plurality of users for a point of attention and transition of comments in time series.

### Third Embodiment

An image processing system according to a third embodiment of the present invention is explained with reference to the drawings.

In the first embodiment, besides a portion where an annotation is added and a display magnification, user information is stored as a list to make it easy to identify a user when the annotation is presented to the user. In the second embodiment, not only annotations in the same place but also a plurality of annotations added to regions of interest in different places are grouped to make it possible to accurately present necessary information and focus efforts on diagnosis work. In the third embodiment, “user attribute” information is added anew to the items of the annotation list to make it possible to smooth a work flow in pathology diagnosis. In the work flow in the pathology diagnosis, a plurality of users (e.g., a technician, a pathologist, and a clinician) adds annotations to the same image with different purposes (viewpoints, roles) or with different methods (e.g., automatic addition by image analysis and addition by visual observation). The user attribute is information indicating purposes (viewpoints, roles) or methods at the time when the users add annotations. In the third embodiment, the components explained in the first embodiment can be used except the configuration of an annotation list and a flow of annotation addition.

(Example of an Annotation Data List)

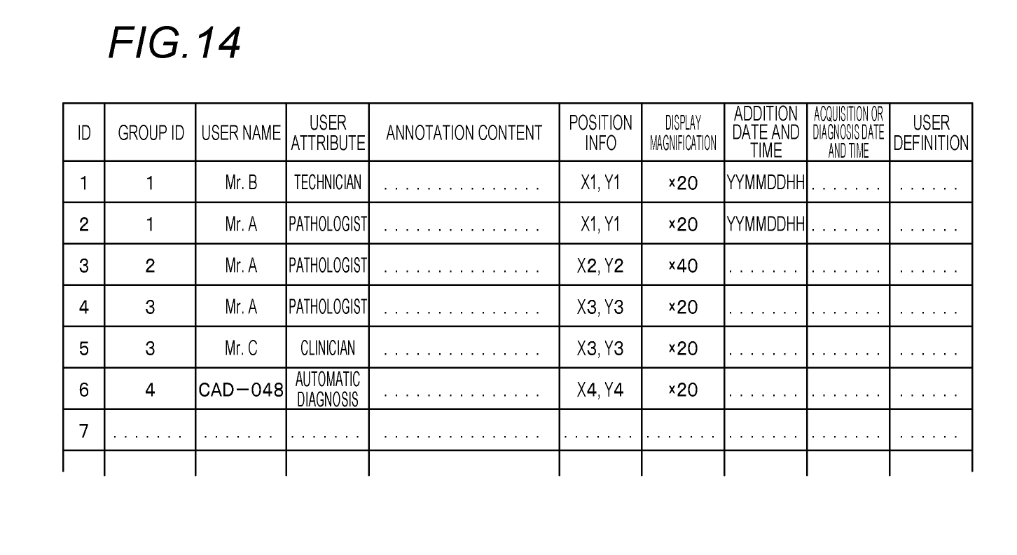

FIG. 14 shows the configuration of an annotation data list generated by the image processing apparatus 102 according to this embodiment.

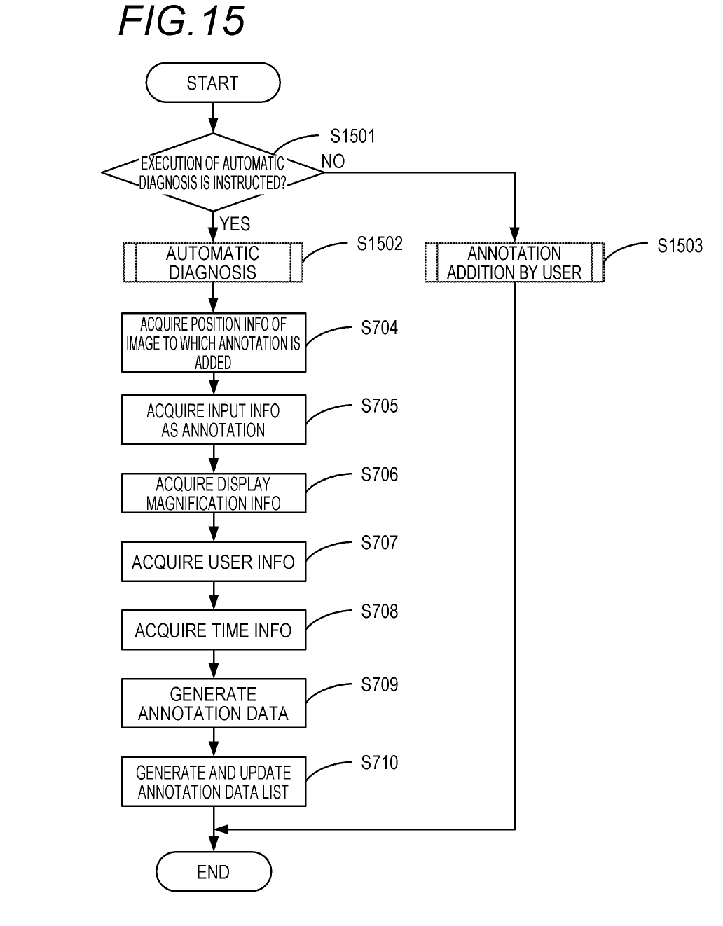

The annotation list used in the first embodiment is already shown in FIG. 10 and explained. FIG. 14 is different from FIG. 10 in that “user attribute” is added as a list item. The “user attribute” indicates attributes of users who add annotations. For example, “pathologist”, “technician”, “clinician”, and “automatic diagnosis” are conceivable. However, annotation addition by the automatic diagnosis is performed according to a procedure different from annotation addition by humans such as a pathologist, a technician, and a clinician. Therefore, a procedure of annotation addition in this embodiment is explained below with reference to FIG. 15. In FIG. 14, an attribute name is directly stored as the user attribute. However, a list of a relational database format may be used in which a table that stores a user attribute ID instead of the attribute name and stores a user attribute ID and a user attribute name separately from the user attribute ID is prepared.

When a work flow of general pathology diagnosis is taken into account, diagnosis work is made more efficient by preparing the user attribute. For example, in the general pathology diagnosis, data concerning a slide flows from the technician to the pathologist and the clinician in this order. However, other pathologists may be involved between the pathologist and the clinician. In view of this, in diagnosis using this embodiment, it is conceivable that, after an image of the slide is acquired, first, the technician performs screening and adds an annotation to a place to which the technician desires that the pathologist pays attention. When the technician uses some automatic diagnosis function, an annotation is added by software of the automatic diagnosis function. It is conceivable that, subsequently, the pathologist adds, with reference to the annotation added by the technician, annotations to place necessary for diagnosis such as abnormal part of a specimen on the slide and a normal part serving as a reference. When the pathologist uses the automatic diagnosis function, an annotation is added by the software as in the case of the technician. When diagnosis is performed by a plurality of pathologists, it is conceivable that an additional annotation is added with reference to an annotation of a pathologist who performs diagnosis earlier. It is conceivable that, thereafter, when the slide data reaches the clinician, the clinician understands a diagnosis reason with reference to the annotation added by the pathologist. In understanding the diagnosis reason, when there are annotations added by the technician and the automatic diagnosis function, the clinician does not have to refer to excess information by not displaying the annotations as appropriate. Naturally, like the technician and the pathologist, the clinician can add an opinion concerning the slide as an annotation. Even if the slide data is delivered to a clinician in another hospital in order to obtain a second opinion, as in the case of the clinician, the clinician in the other hospital can perform diagnosis with reference to various annotations added in the past. In this way, the user attribute is associated with an annotation as one kind of user information to make it possible to change a display form of the annotation for each user attribute and switch display and non-display of the annotation. Consequently, in respective stages of the pathology diagnosis work flow, it is easy to grasp characteristics of respective kinds of annotation information and select information and smooth pathology diagnosis work.

(Addition of an Annotation)

FIG. 15 is a flowchart for explaining an annotation addition procedure in this embodiment. In FIG. 15, a flow of annotation addition at the time when user attributes including automatic diagnosis are added as items of the annotation list is explained.

In step S1501, it is determined whether an execution instruction for automatic diagnosis software is received from the user. When the execution instruction is received, the processing proceeds to step S1502. When the instruction is not received, the processing proceeds to step S1503.

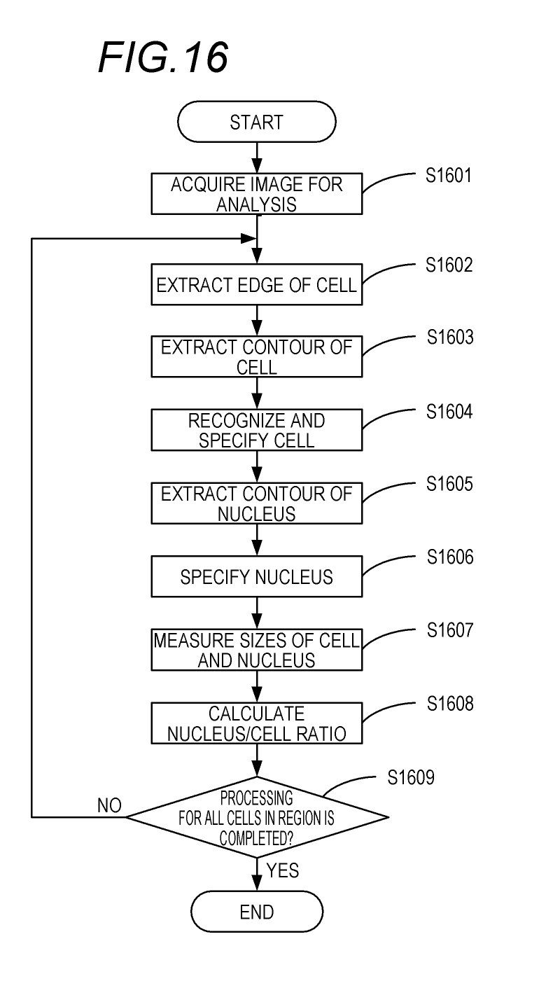

In step S1502, the automatic diagnosis software executes the automatic diagnosis according to the execution instruction of the user. Details of the processing are explained below with reference to FIG. 16.

In step S1503, annotation addition is performed by the user. Details of the processing in step S1503 is the same as the processing shown in FIG. 7.

Processing contents of annotation addition indicated by steps S704 to S710 are substantially the same as the contents explained with reference to FIG. 7 in the first embodiment. However, steps S704 and S705 in this embodiment are different from the first embodiment in that position information and input information are acquired from an output result of the automatic diagnosis software. Step S707 in this embodiment is different from the first embodiment in that user information is acquired from the automatic diagnosis software.

(Example of an Automatic Diagnosis Procedure)

FIG. 16 is a flowchart for explaining an example of an automatic diagnosis execution procedure. In FIG. 16, an example of a flow in which an automatic diagnosis program performs image analysis and generates diagnosis information is explained.

In step S1601, the automatic diagnosis program performs acquisition of an image for analysis. Histological diagnosis is explained as an example. The histological diagnosis is applied to a specimen obtained by HE-dying a thin-sliced tissue piece.

In step S1602, the automatic diagnosis program extracts an edge of an analysis target cell included in the acquired image. To facilitate the extraction processing, edge enhancement processing by a spatial filter may be applied beforehand. For example, it is advisable to detect a boundary of cell membranes from regions of the same color making use of the fact that the cell is dies in red to pink by eosine.

In step S1603, the automatic diagnosis program extracts a contour of the cell on the basis of the edge extracted in step S1602. When the edge detected in step S1602 is discontinuous, it is possible to extract a contour portion by applying processing for joining discontinuous points of the edge. The joining of the discontinuous points may be performed by general linear interpolation. A high-order interpolation formula may be adopted in order to further improve accuracy.

In step S1604, the automatic diagnosis program performs recognition and specification of the cell on the basis of the contour detected in step S1603. In general, a cell is circular. Therefore, it is possible to reduce determination errors by taking into account the shape and the size of the contour. It is difficult to specify some cell because overlap of cells occurs in a part of the cell. In that case, the processing for recognition and specification is carried out again after a specification result of a nucleus at a later stage is obtained.

In step S1605, the automatic diagnosis program extracts a contour of the nucleus. In step S1602, the automatic diagnosis program detects the boundary of cell membranes making use of the fact that the cell is dies in red to pink by eosine. The nucleus is dies in bluish purple by hematoxylin. Therefore, in step S1605, it is advisable to detect a region, the center portion (a nucleus) of which is bluish purple and the periphery (a cytoplasm) of which is red, and detect a boundary of a region of the bluish purple center portion.

In step S1606, the automatic diagnosis program performs specification of the nucleus on the basis of contour information detected in step S1605. In general, the size of a nucleus is about 3 to 5 um (micrometers) in a normal cell. However, when abnormality occurs, various changes such as enlargement of the size, multinucleation, and deformation occur. Inclusion in the cell specified in step S1604 is one of signs of the presence of the nucleus. Even the cell hard to be specified in step S1604 can be determined by specifying the nucleus.

In step S1607, the automatic diagnosis program measures the sizes of the cell and the nucleus specified in step S1604 and step S1606. The sizes indicate areas. The automatic diagnosis program calculates the area of the cytoplasm in the cell membrane and the area in the nucleus. Further, the automatic diagnosis program may count a total number of cells and obtain statistic information concerning the shapes and the sizes of the cells.

In step S1608, the automatic diagnosis program calculates an N/C ratio, which is a ratio of the cytoplasm and the nucleus, on the basis of area information obtained in step S1607. The automatic diagnosis program obtains statistic information of results of the calculation concerning the respective cells.

In step S1609, the automatic diagnosis program determines whether the analysis processing concerning all the cells is completed within a region of the image for analysis and, in some case, within a range designated by the user. When the analysis processing is completed, the automatic diagnosis program completes the processing. When the analysis processing is not completed, the automatic diagnosis program returns to step S1602 and repeats the analysis processing.

As a result of the analysis, it is possible to extract a place having a large N/C ratio where abnormality is suspected and add annotation information to the extracted place.

(Effects of this Embodiment)

As the information stored in the annotation list, the user attribute is used besides the user name. Therefore, it is possible to identify an annotation from the viewpoint of the pathology diagnosis work flow. For example, it is advisable to vary a display form of an annotation when the annotation is added by the automatic diagnosis and when the annotation is added by the user. The display form may be varied when the user is a technician and when the user is a physician (a pathologist, a clinician, etc.). Further, the display form may be varied when the user is the pathologist and when the user is the clinician. Consequently, even if a large number of annotations are present, it is possible to more clearly present contents of a comment and transition of the comment according to job content of the user who refer to the annotations.

### OTHER EMBODIMENTS

The object of the present invention may be attained by the following. A recording medium (or a storage medium) having recorded therein a program code of software for realizing all or a part of the functions of the embodiments explained above is supplied to a system or an apparatus. A computer (or a CPU or an MPU) of the system or the apparatus reads out and executes the program code stored in the recording medium. In this case, the program code itself read out from the recording medium realizes the functions of the embodiments. The recording medium having the program code recorded therein non-temporarily configures the present invention.

The computer executes the read-out program code, whereby an operating system (OS) or the like running on the computer performs a part or all of actual processing on the basis of an instruction of the program code. The functions of the embodiments are realized by the processing. This case is also included in the present invention.

Further, the program code read out from the recording medium is written in a memory included in a function extended card inserted into the computer or a function extended unit connected to the computer. Thereafter, a CPU or the like included in the function extended card or the function extended unit performs a part or all of actual processing on the basis of an instruction of the program code. The functions of the embodiments are realized by the processing. This case is also included in the present invention.

When the present invention is applied to the recording medium, a program code corresponding to the flowcharts explained above is stored in the recording medium.

The configurations explained in the first to third embodiments can be combined with one another. For example, a configuration may be adopted in which the image processing apparatus is connected to both of the imaging apparatus and the image server and can acquire an image used for the processing from both the apparatuses. Besides, configurations obtained by appropriately combining various techniques in the embodiments also belong to the category of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-283723, filed on Dec. 26, 2011 and Japanese Patent Application No. 2012-219498, filed on Oct. 1, 2012, which are hereby incorporated by reference herein in their entirety.

### REFERENCE SIGNS

101: imaging apparatus, 102: image processing apparatus, 103: display apparatus, 301: image-data acquiring unit, 305: annotation-data generating unit, 306: user-information acquiring unit, 308: annotation data list, 309: display-data-generation control unit

1. An image processing apparatus comprising:
an acquiring unit that acquires data of an image of an object, and data of a plurality of annotations added to the image; and
a display control unit that displays the image on a display apparatus together with the annotations, wherein
the data of the plurality of annotations includes position information indicating positions in the image where the annotations are added, and information concerning a user who adds the annotations to the image, and
the display control unit groups a part or all of the plurality of annotations and, when the plurality of annotations are added by different users, the display control unit varies a display form of the annotation for each of the users and displays the plurality of annotations while superimposing the annotations on the image.

2. The image processing apparatus according to claim 1, wherein
a plurality of users add annotations to the image with different purposes or with different methods,
the information concerning the users includes a user attribute indicating the purpose or method at the time when each of the users add the annotation, and
the display control unit varies a display form of the annotation for each of the user attributes.

3. The image processing apparatus according to claim 1, wherein the display control unit varies the display form of the annotation when the annotation is added by automatic diagnosis and when the annotation is added by the user.

4. The image processing apparatus according to claim 1, wherein the display control unit varies the display form of the annotation when the user is a technician and when the user is a physician.

5. The image processing apparatus according to claim 1, wherein the display control unit varies the display form when the user is a pathologist and when the user is a clinician.

6. The image processing apparatus according to claim 1, wherein the data of the image acquired by the acquiring unit includes data of hierarchical images formed by a plurality of images of a same object with resolutions that differ stepwise.

7. The image processing apparatus according to claim 1, wherein the display control unit groups, on the basis of the position information, annotations added to a same region of interest in the image among the plurality of annotations.

8. The image processing apparatus according to claim 1, wherein the display control unit groups, on the basis of the position information, annotations added to a same position in the image among the plurality of annotations.

9. The image processing apparatus according to claim 1, wherein the display control unit groups annotations designated by the user among the plurality of annotations.

10. The image processing apparatus according to claim 1, wherein
the data of the plurality of annotations further includes information concerning a date and time when the annotations are added, and
the display control unit displays annotations belonging to a same group in time order on the basis of the information concerning the date and time.

11. The image processing apparatus according to claim 1, wherein
the data of the plurality of annotations further includes information concerning a date and time when the annotations are added, and
the display control unit varies a display form for each of annotations added in different periods.

12. An image processing system comprising:
the processing apparatus according to claim 1; and
a display apparatus that displays an image and an annotation output from the image processing apparatus.

13. An image processing method comprising:
an acquiring step in which a computer acquires data of an image of an object, and data of a plurality of annotations added to the image; and
a display step in which the computer displays the image on a display apparatus together with the annotations, wherein
the data of the plurality of annotations includes position information indicating positions in the image where the annotations are added, and information concerning a user who adds the annotations to the image, and
in the display step, the computer groups a part or all of the plurality of annotations and, when the plurality of annotations are added by different users, the computer varies a display form of the annotation for each of the users and displays the plurality of annotations while superimposing the annotations on the image.

14. A non-transitory computer readable storage medium storing a program for causing a computer to execute the steps of the image processing method according to claim 13.
